(19) United States
(12) Patent Application Publication
(10) Pub. No.: US 2024/0103960 A1
(43) Pub. Date: Mar. 28, 2024

(54) OPERATIONAL INTELLIGENCE PLATFORM

(71) Applicant: Yondr Group Holdings B.V., Amsterdam (NL)

(72) Inventor: Paul James Cook, Glasgow (GB)

(21) Appl. No.: 18/001,964

(22) PCT Filed: Dec. 14, 2022
(86) PCT No.: PCT/IB2022/062218

§ 371 Date: Dec. 15, 2022

Related U.S. Application Data
(60) Provisional application No. 63/289,593, filed on Dec. 14, 2021.

(51) Int. Cl. G06F 11/07

(52) U.S. Cl. CPC G06F 11/0793; G06F 11/079

(57) ABSTRACT

Approaches for monitoring and managing one or more operational components of a data center are provided. Data for one or more applications associated with operational functionalities may be received. The one or more applications may be associated with one or more related applications. A failure of one or more components monitored by the one or more applications or the one or more related applications can be detected. A cause of the failure can be determined based, at least in part, upon detected changes and contextual information associated with the failure. At least one change can be made to the components based on the determined cause.

### CROSS-REFERENCE TO RELATED APPLICATIONS

This application claims priority to and the benefit of PCT Application Serial No. PCT/IB2022/062218 filed Dec. 14, 2022 titled “OPERATIONAL INTELLIGENCE PLATFORM” and U.S. Provisional Application Ser. No. 63/289,593 filed Dec. 14, 2021 titled “OPERATIONAL MANAGEMENT PLATFORM,” the full disclosures of which are hereby incorporated herein by reference in their entirety for all purposes.

### BACKGROUND

Users and service providers are increasingly relying on electronic computing resources available at one or more data centers for various computing needs. Several operational requirements of a data center may include building management systems (BMS), power management systems (PMS), heating, ventilation, and air conditioning systems (HVAC), fire alarm systems, network management systems, battery management systems, open weather API, and integration with third party systems, among other requirements. However, operational systems of a data center are often run independently of each other, with separate systems being monitored by separate entities. In a case of a failure, it may be difficult to determine a source of the failure with a high degree of accuracy, partially due to the large number of entities involved. For example, if a temperature sensor reads at a high temperature, it may be difficult and time-consuming for a data center provider to pinpoint a cause of the high temperature, especially in cases where one or more operational systems do not communicate with each other.

Additionally, various components may indirectly cause operational issues over time. A technician may not be able to directly observe components and determine how they may impact downstream operations. Further, technicians may take different shifts and may overlook potential causes for operational failures.

### BRIEF DESCRIPTION OF THE DRAWINGS

Various embodiments in accordance with the present disclosure will be described with reference to the drawings, in which:

FIG. 1 illustrates an example interface that can be utilized to implement one or more embodiments.

FIG. 2 illustrates another example interface that can be utilized in accordance with one or more embodiments.

FIG. 3 illustrates an example control system for controlling one or more components of a data center cooling system, in accordance with various embodiments.

FIG. 4 illustrates an example method that can be utilized in accordance with one or more embodiments.

FIG. 5 illustrates an environment in which various embodiments may be implemented in accordance with various embodiments.

FIG. 6 illustrates an example environment that can be utilized in accordance with various embodiments.

### DETAILED DESCRIPTION

In the following description, various embodiments will be described. For purposes of explanation, specific configurations and details are set forth in order to provide a thorough understanding of the embodiments. However, it will also be apparent to one skilled in the art that the embodiments may be practiced without the specific details. Furthermore, well-known features may be omitted or simplified in order not to obscure the embodiment being described.

Operating a data center may require substantial human involvement, where a technician working in one area of operations might not even have contact with other technicians working in other areas. As such, in a case of a failure of a component in a data center, it may become cumbersome to determine a source of the failure given the number of bodies independently operating and managing individual components within the data center. Data within an integrated platform may be provided in a data structure including multiple parent nodes associated with multiple children nodes, and the data may be presented relative to a single asset with all relevant data associated with the asset in a single view. In this way, a fewer number of technicians may be required to monitor and control operations of the data center. One or more neural networks may be utilized, in accordance with various embodiments, to observe environmental changes within the data center and generate associations between data points. Based on the changes, the one or more neural networks can be utilized to generate recommendations or automatically implement changes to the environment.

An integrated, centralized platform may enable quicker detection and diagnosis of one or more operational failures because in such a platform, a technician may be able to quickly to analyze and determine a cause or a root cause of the failure. For example, a failure may be indicated in the platform with a corresponding time stamp. A technician may then be able to back-track from that time stamp, analyze various operations on a single screen, and determine what actually caused the failure. A root cause of the failure may be distinguishable from a perceived failure, as a perceived failure may be a result of a root cause of the failure. As a result, operational uptime may be increased due to a resilient load balance and reduction in monitoring redundant architecture. In at least some example embodiments, artificial intelligence may be utilized to generate suggestions and recommendations to save energy. For example, at least one neural network can be trained to recognize environmental changes and behaviors to infer a cause of changes and recommend corrective actions to be taken. As used herein, “artificial intelligence” may include, but is not limited to, machine learning, natural language processing, neural networks, random forest models, and other such algorithms or models.

Such a platform may be managed remotely, hosted on a cloud-based service. Additionally, a platform may be provided on-premise options, depending on the needs of a client and available building systems and data network connectivity. Scalable architecture within the system may enable the system to scale with new sites, while minimizing risks of system down-time associated with relocation and scaling. The platform may also be integrated with data centers hosted by different providers. In at least some embodiments, the system can be controlled automatically, without human intervention. For example, the system may use artificial intelligence or threshold management techniques to determine when to automatically cut power to one or more components of the system, or determine to change operating conditions of one or more components to optimize energy savings while maintaining suitable operations.

According to an example embodiment, one or more components within a data center may be controlled remotely through the platform, such that a technician working from a remote location may be able to adjust conditions such as temperature and humidity of the data center, or a fan speed of a fan wall unit operating within the data center. Such data may be provided to the platform in real time, so that a technician may be able to adjust one or more system metrics to improve the efficiency of the data center. Additionally, control logic may be implemented which may make proactive decisions to optimize efficiency, such as lowering a power load or increasing fan speeds.

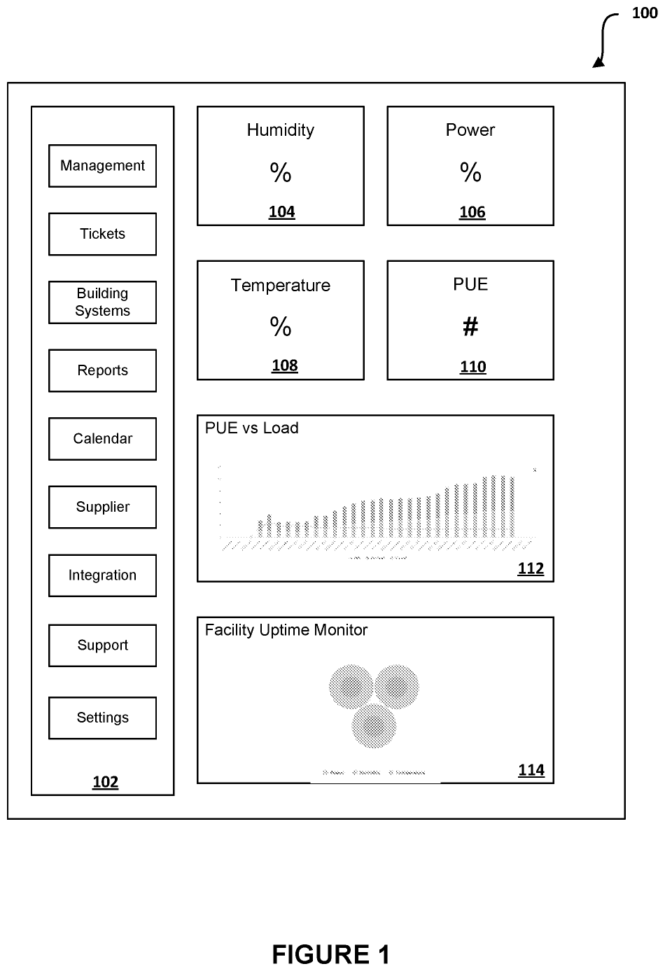

FIG. 1 illustrates an example interface 100 that can be utilized to implement one or more embodiments. In accordance with an example embodiment, a user may access, through an interface 100, features related to operations of a data center. A platform for monitoring and operating a data center according to an example embodiment may integrate with multiple systems and data sources. For example, a computer-aided facility management (CAFM) ticket management system may be integrated with relevant system data, to enable an operations team to pinpoint operational failures within the data center system. Additionally, a platform may be integration-ready for any internal or external system with fine grain controls implementing role-based access control (RBAC) for data, such as API data. Developers, technicians, and customers may then be provided with programmatic access to the platform. Third-party vendors may also be provided access to the platform, and access may be restricted to information determined to be relevant for the vendor. In accordance with an example, an active directory may be integrated, providing role-based access control to the platform. For example, a technician may have different permissions than a customer of a data center. Depending on one or more needs of the user, permissions for access to the platform, as well as for various features of the platform, may be changed. Changes may be pushed in real time such that a customer who may require access to a module they would otherwise not have permission to may be granted access without delay.

Additionally, multi-factor authentication may be utilized when providing access to the platform. For example, when requesting access to the platform, a user may be required to provide login credentials along with a separate token to log into the platform. For added security, a full audit trail of a user may be logged, along with any system activity. According to another example, visitor and contractor management for data center request (DCR) may be provided within a platform. For example, a visitor or contractor may request access to a physical site, or may submit a request to work on specific assets if the visitor or contractor are not within the host location's network.

Using a dashboard 102 or other type of navigational tool, a user may be able to manage or view data associated with one or more environments. For example, a user may be able to view and manage data associated with one or more data centers of various regions. In accordance with an example embodiment, data may be uniquely integrated, using a data structure including multi-parent and multi-child data formats having common naming schemes. In this way, operational data associated with various aspects of a data center may be easily integrated into a platform, and the data may be easily associated across operations. Operations which are independently monitored may then be associated with other independent operations to provide meaningful insights to a user.

In accordance with an example embodiment, one or more widgets may be provided for display. The one or more widgets may be dynamically provided depending upon one or more permissions granted to a user. Widgets may include usage data, statistical data, performance data, status information, service ticket information, and environmental data, among others. Usage data may include plant availability usage, power usage effectiveness (PUE) provided as a PUE index, PUE versus site supply versus IT load history, and a PUE average for a given time period. Usage data may also include data showing a total amount of energy consumed at a specific site, or a total amount of water consumed at a specific site. Other usage data may include fuel usage and real-time carbon usage. In this example, a user may be able to see one or more data points including humidity 104, power 106, temperature 108, and PUE 110. These data points may be provided in real-time, as well as in a daily/weekly/monthly report. For example, a PUE report may provide insights as to the energy efficiency of a data center. PUE may be a measurement of how much energy is used by the computing equipment within the data center. According to an example, PUE may be represented as a ratio of the total amount of energy used by a computer data center facility to the energy delivered to the computing equipment within the data center.

A user may want to see related and unrelated data in a single report. An example centralized platform may provide one or more functionalities to enable a user to select the data series they would like to see, regardless of whether the data is related to other data series in the platform, and generate a report for the user. Reports may be scheduled such that reports may be delivered directly to users on a daily, weekly, and monthly schedule, as may be required for a user. Reports may also be provided with a single click, and the reports may reflect real-time data. In conventional systems, reports covering such a numerous number of components may have taken weeks to create. With an integrated solution, reports may be provided much more quickly and accurately than these conventional systems. Reports may be exported to a user in various formats, such as a spreadsheet, document file, or a portable document format.

One or more insights such as a PUE vs load graph 112 may be generated and provided for presentation on the interface 100. Insights may also include facility uptime monitor 114, among other such insights. According to an example embodiment, the interface may enable a client, supplier, or other such user to access one or more configurable widgets, including user-defined dashboards and other interactive and live information. Such a platform may be used on a desktop, tablet, and mobile devices, among other such devices.

One or more benefits of a centralized platform may include cost optimization due to continuous improvement to operational efficiency. For example, such a system may enable energy savings and expenditure on physical workers running operations at a given location. Additionally, predictive maintenance may beneficially detect changes in system behavior and indicate early maintenance problems before failure. For example, one or more maintenance recommendations may be provided to a user in advance of a failure using data such as the age of one or more components or learned behaviors of the one or more components. In at least some example embodiments, cost savings may be calculated and provided to a user so that a user may use the cost information and maintenance recommendation to determine whether it would be more expensive to wait to replace a component.

While this example relates to the presentation of data points, graphs, and monitors, other information may be provided for display. For example, an interface may also be used to provide a user with health and safety compliance information, in addition to graphical views of people on site, health and safety near-misses, and events by location. A centralized platform may provide for operational visibility into one or more operational aspects of a data center. For example, a single platform may provide visibility into, among other aspects, a building management system (BMS), a power management system (PMS), HVAC, a fire alarm system, network management, battery management, open weather API, cloud-based storage and synchronization service integration, and third-party systems. Third party systems may include asset management systems, maintenance services, document management services, record keeping services, e-mail and messenger systems, and human resources services. In accordance with an example embodiment, workflows may be provided to a user to support on-site compliance requirements, such as new inspection workflows and walkaround processes.

One or more widgets of an interface may also provide statistical information, including, but not limited to, a total amount of assets added to a third-party system, such as an assets management software. Other statistics may include one or more metrics providing insights to data center infrastructure efficiency (DCIE), a statistic showing a delta between environment or ambient values over time. According to another example, one or more widgets may also provide an executive view of an incident count, or incident count per category, and may be mapped as a measure of current values versus historical values. Other statistics according to an example may include one or more figures representing an IT load and a total IT load.

One or more charts may also be provided according to an example, such as a chart to show PPM request statistics, a chart to show problem request statistics, and a chart to show completed request statistics. A total site load distribution may be provided as a pie chart, according to another example, and one or more site load metrics and historical site metrics may be provided in one or more widgets.

According to another example, statistics may also include a percentage of uptime for a time period with respect to one or more metrics such as humidity, power, and temperature. A historical performance of uptime of temperature, humidity, and power may also be provided. Additionally, according to another example, a total facility uptime may be provided, and may be shown as a comparison to a total target amount.

For a given platform, health status information may also be provided in one or more widgets. For example, a building management system (BMS) sensor status may be provided for one or more components of a data center. Other status information may include information about a generator availability for one or more generators associated with a data center. According to another example, a status regarding one or more services that are running may be provided. An electrical health status of a site and/or a mechanical health status of a site may also be provided, as well as an electrical capacity. One or more health statuses may be provided for all systems, in real time.

According to another example, one or more widgets for a platform may show graphical relational views of one or more systems and their end points related to one or more data center assets (e.g., generators). One or more widgets may also be provided to show changes in an application's development, such as a change log showing changes made at specific points in time. One or more widgets according to another example may provide a list of critical work areas, a list of the most recent incident records, and/or a count of the total incident reports.

Because weather conditions may impact the overall efficiency of a data center, weather data and weather history data may be provided in the form of a chart or a table on an example platform. Such information may be beneficial in cases of operational system changes, reconfiguration of building systems, plant replacement, or systems redesign on current or future projects.

According to an example, a platform for monitoring and operating a data center may include a document management system which may be fully integrated with the platform. In such a system, a user may access one or more files from a centralized platform related to specific assets, without having to toggle between other file management systems.

An example platform may also enable bug and feature request submission, while being fully integrated with work management software and project management tools to track for issues and bugs. In this way, a user of the platform might not need to log into separate services to manage one or more operational aspects of a data center.

Within an example platform, one or more training videos may be provided for how to use the platform and perform specific tasks. Additionally, one or more tooltips may be provided within the platform to inform a user of various features of the platform, or to suggest recommendations for actions a user may take with respect to a given widget. Terminology explanations may also be provided so a user can fully understand and appreciate what they are looking at.

In an example data center environment, water management may make up a significant portion of operations because water may be used in chiller units for cooling down the data center. Therefore, according to an example, a platform for monitoring a data center may include a module for water management, where site water consumption and discharge may be calculated and analyzed to provide insights for water efficiency within the system.

Service-Level Agreement (SLA) reports may also be provided to a user, providing a calculation of the percentage of time in which acceptable service levels were maintained for the resources included in the report. For example, a user may be provided with runtime reports explaining how long various components of a data center were in full operation for a specified time period. In accordance with an example embodiment, a user may be notified of tickets that have breached an SLA or that are in danger of breaching their SLA. The notifications may be automatically generated based on analyzed data. For example, a data point falling below an agreed-to value for a determined period of time may be indicative of a potential breach of an SLA. A user subject to the SLA may be provided with a notification of the event. In at least some example embodiments, the user may also be provided with suggested corrective actions to prevent future failures.

An overall data center status and availability status may be provided in the platform, as well as availability for individual components within the data center. For example, a user may be able to see a status of one or more components of a chiller system, as well as one or more components of an electrical system powering the chiller system and computer components within the data center. According to another example embodiment, a live or rolling view for network operations center (NOC) or a network management center (NMC) may be provided.

A platform according to an example may include a module for risk assessment, which may include an estimated production availability of a system by assessing failure modes, frequencies, and consequences. According to an example, an asset impact assessment may be provided within the module or separately from the module to predict or model any operational issues which may happen down-stream when a circuit breaker is switched off. The asset impact assessment may be integrated with or otherwise associated with one or more other monitored components, to maintain a real-time update of the system.

According to an example embodiment, planned preventative maintenance (PPM) tools and a calendar view may be provided. For example, a calendar extract of PPM tasks visualized in Data Center Operations (DCOps) can be shown with a current SLA status, so that a user can easily analyze the task and determine what operations may need to be addressed at any given time.

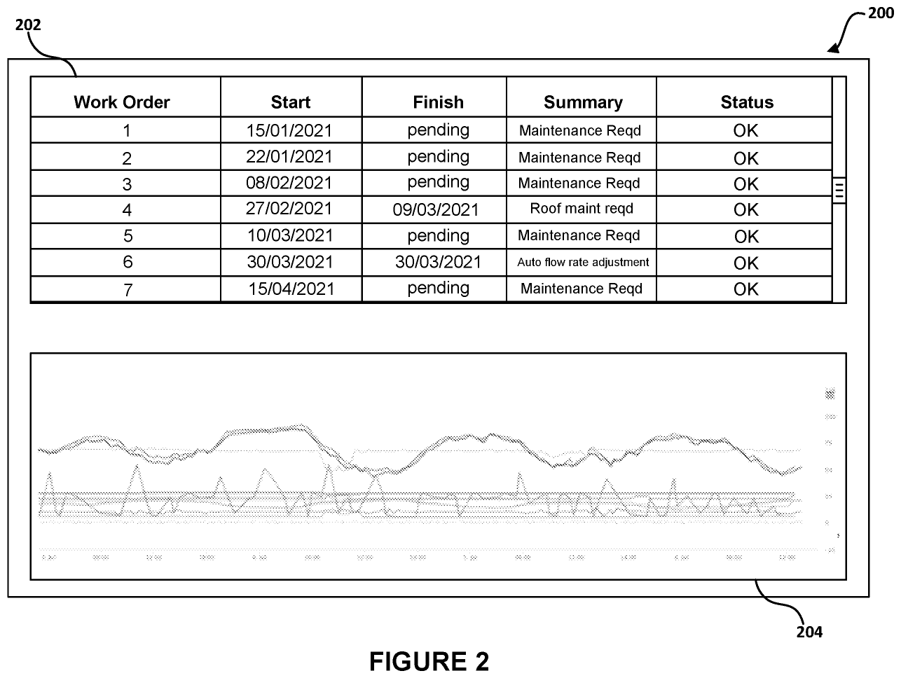

FIG. 2 illustrates another example interface 200 that can be utilized in accordance with one or more embodiments. In this example, a user may be able to view information associated with one or more work orders 202. Work orders may be utilized to alert a user to one or more problems which may need to be addressed, and the work orders may be specific to a facility, or to a component within a facility. Operational maintenance may also be optimized, using work orders or other types of service tickets that can be raised in reaction to incidents, ticket performance monitoring, operational blueprint process library, time and resource monitoring, and collaborative safety tools, among other such options. Using processing logic associated with the platform, service tickets may be raised automatically in response to detected rates of change of one or more metrics within a data center. Technicians may then be notified quickly of the issue, rather than waiting for a user to raise a ticket. Additionally, because data for nearly all assets within a data center may be provided in a centralized manner, a technician may easily determine why the service ticket was raised, as well as how to address the issue raised in the ticket. In some example embodiments, maintenance tasks may be automatically scheduled.

A total ticket count may also be provided in a widget, in addition to a total user count for a system or portions of a system and associated permissions assigned to specific users. In at least one example embodiment, tickets may be automatically allocated to a technician based on the technician's skillset. For example, if a technician has particular skills to address a problem, that technician may be automatically assigned to handle the task.

In an example widget for a ticket service, or provided separately from a widget for a ticket service, a work order summary may be provided. This summary may be ranked based on a risk classification. According to an example, risk level may be automatically determined and classified. For example, if power supplied to critical areas fall outside of one or more determined thresholds, an increased risk category risk ticket may be raised without technician intervention. Risk may be classified as being low, intermediate, and high, depending on the determined threshold values. In other embodiments, risk level may be manually determined by technicians.

As shown, work orders may have corresponding information including, but not limited to, start dates, finish dates, summaries, and status. Work order number 6 shows that the system automatically adjusted a flow rate of one of the components within the environment. In accordance with an example embodiment, flow rate may be adjusted in response to the system determining that a corrective action is needed for the component. The system may make such a determination using, at least in part, a neural network or other form of artificial intelligence.

Also shown in the example of FIG. 2 is a line graph 204 of various data points over time for various sensors. For example, outside air temperature, outside air humidity, fresh air temperature, return air temperature, flow rate values, and other types of values may be recorded and provided for display. In this way, it can be easy to visualize different types of data for a specific environment.

In accordance with an example embodiment, a workflow engine may be used to assign workload items to a user, such as through work orders or other methods of task assignment. One or more aspects of an example workflow engine may include a universal workflow and automation designer engine. Such an engine may include computer-aided facilities (CAFM) functionalities, including administrative tools and the ability to track, manage, report, and plan one or more operations of a data center.

A workflow engine may be Business Process Model and Notation (BPMN) compatible so that the end-to-end orchestration of the workflows may be graphically provided in a business process model. According to an example, one or more visualizations of a workflow and current status of the workflow may be provided on the platform. Through the visualizations, bottlenecks in operational workflows may be easily recognizable or determinable, enabling a user to optimize processes which may be causing the bottleneck.

Reports related to the estimated production availability may be generated, in addition to any other reports pertaining to any of the components associated with the system. Additionally, a live view of active incident management may be provided, along with a root cause analysis for any incidents. A root cause analysis according to an example may include observations, near-misses, and accidents. If a critical component within a data center fails, the component may be identified as being high priority, and may be provided to a ticket management system, integrated with the platform, with high urgency. A technician may be provided with a notification or message, in the ticket management system or in another module of the system, regarding a critical component failure, along with a location of the component for ease of identification.

One or more reports according to another example may provide one more site metrics to a user. For example, reports may include metrics related to the operation of a chiller unit within a data center, such as temperature, pressure, energy efficiency, emissions and carbon reporting, among other such metrics. Reports may also be provided specifically for critical system availability. Incident reporting from multiple systems may also be provided, indicating an incident related to one or more components within a data center. Notes related to the incident may be automatically or manually entered to indicate a cause, or to potentially provide troubleshooting advice for the incident.

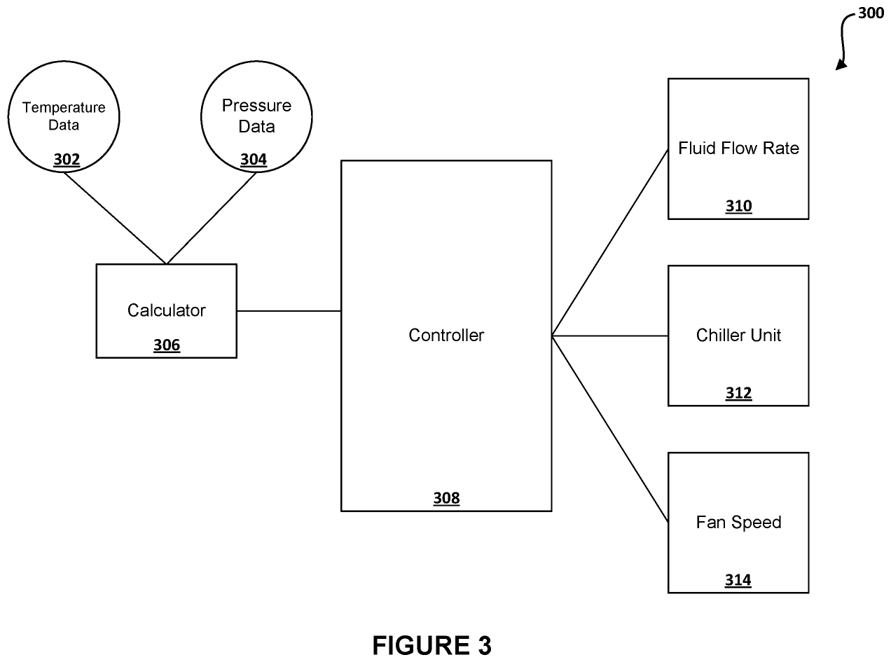

FIG. 3 illustrates an example control system 300 for controlling one or more components of a data center cooling system. According to an embodiment, a control system may include a calculator 306 which may receive at least temperature data 302 and pressure data 304 from one or more temperature and pressure sensors. While this example describes the use of temperature and pressure sensors, other data may be collected from other sensors that can indicate operating conditions related to the environment. A calculator, such as calculator 306, may process temperature data 302 and pressure data 304 to determine a temperature and pressure difference for a cooling system. The calculations may be received by one or more controllers, such as controller 308, to determine one or more control functions for one or more components of a data center cooling system. For example, if a pressure differential is above a determined threshold, a controller such as controller 308 may control a fluid flow rate 310. A controller may include memory and at least one processor configured to execute one or more instructions to control one or more components of the system. A controller may also control other functions such as one or more operations of a chiller unit 312 or one or more fan speeds 314, among other such components. A technician may utilize a centralized platform according to one or more embodiments described herein to locally or remotely monitor and control one or more of these components shown in FIG. 3. In accordance with an example embodiment, one or more components of the system 300 may be automatically controlled, such as through use of artificial intelligence techniques. For example, one or more neural networks may be utilized to analyze operating conditions of various components over time, and perform or otherwise recommend corrective actions to maintain targeted operating conditions.

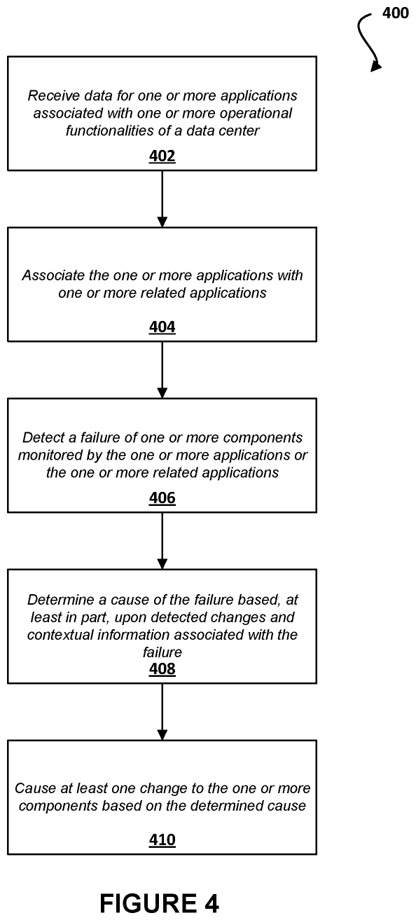

FIG. 4 illustrates an example method 400 that can be utilized in accordance with one or more embodiments. It should be understood that for any process herein there can be additional, fewer, or alternative steps performed in similar or alternative orders, or in parallel, within the scope of the various embodiments unless otherwise specifically stated. In accordance with an example embodiment, data for one or more applications associated with one or more operational functionalities of a data center may be received 402. The one or more applications may be associated with one or more related applications, and provided for display on at least one display interface 404. A failure of one or more components monitored by the one or more applications or the one or more related applications may be detected 406. A cause of the failure may be determined based, at least in part, upon detected changes and contextual information associated with the failure 408. At least one change to the one or more components may be caused based, at least in part, upon the determined cause 410.

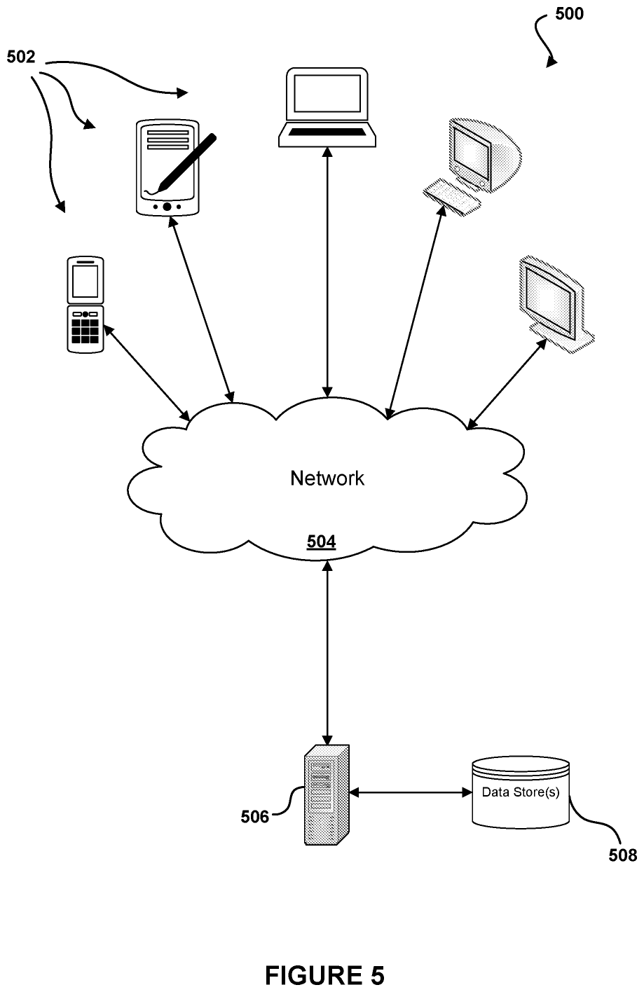

FIG. 5 illustrates an environment 500 in which various embodiments may be implemented in accordance with various embodiments. In accordance with an example embodiment, the environment 500 may include at least one server 506 and one or more data stores 508. It should be understood that there may be several servers, layers, or other elements, processes, or components, which may be chained or otherwise configured, which can interact to perform tasks such as obtaining data from or providing data to an appropriate data store. Data may be backed up daily for all systems and data stores. As may be required by a client, backups may be performed more frequently, such as hourly. Data in the platform may be refreshed in real time, and one or more widgets within the platform may provide a live data indication. In having the data refreshed in real time, a service provider may be able to pinpoint a cause of a failure within the data center quickly and efficiently.

The server 506 may include any appropriate hardware and software for integrating with the data store(s) 508 as needed to execute aspects of one or more applications for the client device and handling a majority of the data access and business logic for an application. A web server may be utilized to serve the application data to the user, in the form of HTML, XML, or another appropriate structured language. In accordance with an example embodiment, the server(s) 506 may include an application-side server and a web server. The handling of all requests and responses, as well as the delivery of content between the client device 502 and the application-side server can be handled by the web server. Requests may be received across a network 504, The network 504 can include any appropriate network, including an intranet, the Internet, a cellular network, a local area network (LAN), or any other such network or combination, and communication over the network can be enabled via wired and/or wireless connections. It should be understood that the Web and application-side servers are not required and are merely example components, as structured code discussed herein may be executed on any appropriate device or host machine.

Each server typically will include an operating system that provides executable program instructions for the general administration and operation of that server and typically will include computer-readable medium storing instructions that, when executed by a processor of the server, allow the server to perform its intended functions. Suitable implementations for the operating system and general functionality of the servers are known or commercially available and are readily implemented by persons having ordinary skill in the art, particularly in light of the disclosure herein.

The environment in one embodiment is a distributed computing environment utilizing several computer systems and components that are interconnected via computing links, using one or more computer networks or direct connections. However, it will be appreciated by those of ordinary skill in the art that such a system could operate equally well in a system having fewer or a greater number of components than are illustrated in FIG. 5. Thus, the depiction of the environment 500 in FIG. 5 should be taken as being illustrative in nature and not limiting to the scope of the disclosure.

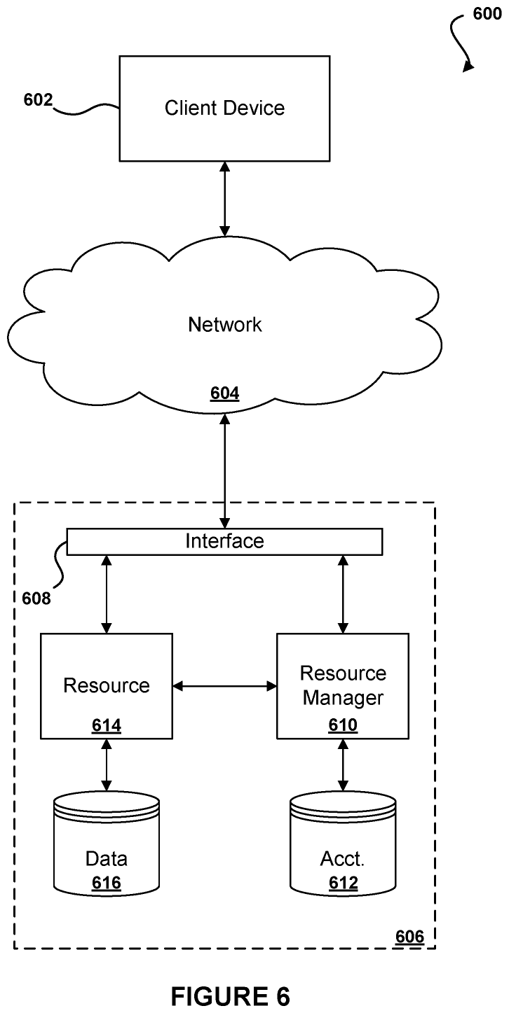

FIG. 6 illustrates an example environment 600 in which aspects of the various embodiments can be implemented. In this example a user is able to utilize at least one client device 602 to submit requests across at least one network 604 to a resource provider environment 606. The client device can include any appropriate electronic device operable to send and receive requests, messages, or other such information over an appropriate network and convey information back to a user of the device. Examples of such client devices include personal computers, tablet computers, smart phones, notebook computers, and the like. The at least one network 604 can include any appropriate network, including an intranet, the Internet, a cellular network, a local area network (LAN), or any other such network or combination, and communication over the network can be enabled via wired and/or wireless connections. The resource provider environment 606 can include any appropriate components for receiving requests and returning information or performing actions in response to those requests. As an example, the provider environment might include Web servers and/or application servers for receiving and processing requests, then returning data, Web pages, video, audio, or other such content or information in response to the request.

In various embodiments, the provider environment may include various types of resources that can be utilized by multiple users for a variety of different purposes. As used herein, computing and other electronic resources utilized in a network environment can be referred to as “network resources.” These can include, for example, servers, databases, load balancers, routers, and the like, which can perform tasks such as to receive, transmit, and/or process data and/or executable instructions. In at least some embodiments, all or a portion of a given resource or set of resources might be allocated to a particular user or allocated for a particular task, for at least a determined period of time. The sharing of these multi-tenant resources from a provider environment is often referred to as resource sharing, Web services, or “cloud computing,” among other such terms and depending upon the specific environment and/or implementation. In this example the provider environment includes a plurality of resources 614 of one or more types. These types can include, for example, application servers operable to process instructions provided by a user or database servers operable to process data stored in one or more data stores 616 in response to a user request. As known for such purposes, the user can also reserve at least a portion of the data storage in a given data store. Methods for enabling a user to reserve various resources and resource instances are well known in the art, such that detailed description of the entire process, and explanation of all possible components, will not be discussed in detail herein.

In at least some embodiments, a user wanting to utilize a portion of the resources 614 can submit a request that is received to an interface layer 608 of the provider environment 606. The interface layer can include application programming interfaces (APIs) or other exposed interfaces enabling a user to submit requests to the provider environment. The interface layer 608 in this example can also include other components as well, such as at least one Web server, routing components, load balancers, and the like. When a request to provision a resource is received to the interface layer 608, information for the request can be directed to a resource manager 610 or other such system, service, or component configured to manage user accounts and information, resource provisioning and usage, and other such aspects. A resource manager 610 receiving the request can perform tasks such as to authenticate an identity of the user submitting the request, as well as to determine whether that user has an existing account with the resource provider, where the account data may be stored in at least one data store 612 in the provider environment. A user can provide any of various types of credentials in order to authenticate an identity of the user to the provider. These credentials can include, for example, a username and password pair, biometric data, a digital signature, or other such information. The provider can validate this information against information stored for the user. If the user has an account with the appropriate permissions, status, etc., the resource manager can determine whether there are adequate resources available to suit the user's request, and if so can provision the resources or otherwise grant access to the corresponding portion of those resources for use by the user for an amount specified by the request. This amount can include, for example, capacity to process a single request or perform a single task, a specified period of time, or a recurring/renewable period, among other such values. If the user does not have a valid account with the provider, the user account does not enable access to the type of resources specified in the request, or another such reason is preventing the user from obtaining access to such resources, a communication can be sent to the user to enable the user to create or modify an account, or change the resources specified in the request, among other such options.

Once the user is authenticated, the account verified, and the resources allocated, the user can utilize the allocated resource(s) for the specified capacity, amount of data transfer, period of time, or other such value. In at least some embodiments, a user might provide a session token or other such credentials with subsequent requests in order to enable those requests to be processed on that user session. The user can receive a resource identifier, specific address, or other such information that can enable the client device 602 to communicate with an allocated resource without having to communicate with the resource manager 610, at least until such time as a relevant aspect of the user account changes, the user is no longer granted access to the resource, or another such aspect changes.

The resource manager 610 (or another such system or service) in this example can also function as a virtual layer of hardware and software components that handles control functions in addition to management actions, as may include provisioning, scaling, replication, etc. The resource manager can utilize dedicated APIs in the interface layer 608, where each API can be provided to receive requests for at least one specific action to be performed with respect to the data environment, such as to provision, scale, clone, or hibernate an instance. Upon receiving a request to one of the APIs, a Web services portion of the interface layer can parse or otherwise analyze the request to determine the steps or actions needed to act on or process the call. For example, a Web service call might be received that includes a request to create a data repository.

An interface layer 608 in at least one embodiment includes a scalable set of user-facing servers that can provide the various APIs and return the appropriate responses based on the API specifications. The interface layer also can include at least one API service layer that in one embodiment consists of stateless, replicated servers which process the externally-facing user APIs. The interface layer can be responsible for Web service front end features such as authenticating users based on credentials, authorizing the user, throttling user requests to the API servers, validating user input, and marshalling or unmarshalling requests and responses. The API layer also can be responsible for reading and writing database configuration data to/from the administration data store, in response to the API calls. In many embodiments, the Web services layer and/or API service layer will be the only externally visible component, or the only component that is visible to, and accessible by, users of the control service. The servers of the Web services layer can be stateless and scaled horizontally as known in the art. API servers, as well as the persistent data store, can be spread across multiple data centers in a region, for example, such that the servers are resilient to single data center failures.

As used herein, the term “data store” refers to any location comprising, among other elements, one or more devices capable of storing, accessing and retrieving data, which may include any combination and number of data servers, databases, data storage devices and data storage media, in any standard, distributed or clustered environment. The environment in one embodiment is a distributed computing environment utilizing several computer systems and components that are interconnected via communication links, using one or more computer networks or direct connections. However, it will be appreciated by those of ordinary skill in the art that such a system could operate equally well in a system having fewer or a greater number of components than are illustrated. Thus, the depiction of the systems herein should be taken as being illustrative in nature and not limiting to the scope of the disclosure.

In embodiments utilizing a Web server, the Web server can run any of a variety of server or mid-tier applications, including HTTP servers, FTP servers, CGI servers, data servers, Java servers and business application servers. The server(s) may also be capable of executing programs or scripts in response requests from user devices, such as by executing one or more Web applications that may be implemented as one or more scripts or programs written in any programming language, such as Java®, C, C# or C++ or any scripting language, such as Perl, Python or TCL, as well as combinations thereof. The server(s) may also include database servers, including without limitation those commercially available from Oracle®, Microsoft®, Sybase® and IBM® as well as open-source servers such as MySQL, Postgres, SQLite, MongoDB, and any other server capable of storing, retrieving and accessing structured or unstructured data. Database servers may include table-based servers, document-based servers, unstructured servers, relational servers, non-relational servers or combinations of these and/or other database servers.

The environment can include a variety of data stores and other memory and storage media as discussed above. In a particular set of embodiments, the information may reside in a storage-area network (SAN) familiar to those skilled in the art. Where a system includes computerized devices, such as a control system or controller of the present disclosure, each such device can include hardware elements that may be electrically coupled via a bus, the elements including, for example, at least one central processing unit (CPU), at least one input device (e.g., a mouse, keyboard, controller, touch-sensitive display element or keypad) and at least one output device (e.g., a display device, printer or speaker). Such a system may also include one or more storage devices, such as disk drives, magnetic tape drives, optical storage devices and solid-state storage devices such as random access memory (RAM) or read-only memory (ROM), as well as removable media devices, memory cards, flash cards, etc.

Such computerized devices can also include a computer-readable storage media reader, a communications device (e.g., a modem, a network card (wireless or wired), an infrared communication device) and working memory. The computer-readable storage media reader can be connected with, or configured to receive, a computer-readable storage medium representing remote, local, fixed and/or removable storage devices as well as storage media for temporarily and/or more permanently containing, storing, transmitting and retrieving computer-readable information. The system and various computerized devices also typically will include a number of software applications, modules, services or other elements located within at least one working memory device, including an operating system and application programs such as a client application or Web browser. It should be appreciated that alternate embodiments may have numerous variations from that described above. For example, customized hardware might also be used and/or particular elements might be implemented in hardware, software (including portable software, such as applets) or both. Further, connection to other computing devices such as network input/output devices may be employed.

Storage media and other non-transitory computer readable media for containing code, or portions of code, can include any appropriate media known or used in the art, such as but not limited to volatile and non-volatile, removable and non-removable media implemented in any method or technology for storage of information such as computer readable instructions, data structures, program modules or other data, including RAM, ROM, EEPROM, flash memory or other memory technology, CD-ROM, digital versatile disk (DVD) or other optical storage, magnetic cassettes, magnetic tape, magnetic disk storage or other magnetic storage devices or any other medium which can be used to store the desired information and which can be accessed by a system device. Based on the disclosure and teachings provided herein, a person of ordinary skill in the art will appreciate other ways and/or methods to implement the various embodiments.

The specification and drawings are, accordingly, to be regarded in an illustrative rather than a restrictive sense. It will, however, be evident that various modifications and changes may be made thereunto without departing from the broader spirit and scope of the invention as set forth in the claims.

What is claimed is:

1. A computer-implemented method, comprising:
receiving data for one or more applications associated with one or more operational functionalities of a data center;
associating the one or more applications with one or more related applications;
detecting a failure of one or more components monitored by the one or more applications or the one or more related applications;
determining a cause of the failure based, at least in part, upon detected changes and contextual information associated with the failure; and
causing at least one change to the one or more components based on the determined cause of the failure.

2. The computer-implemented method of claim 1, wherein the cause of the failure is determined using at least one neural network trained to:
observe and extract the contextual information from a surrounding environment, and
generate one or more recommendations related to the failure.

3. The computer-implemented method of claim 1, further comprising:
generating a service ticket identifying the root cause of the failure; and
providing the service ticket and one or more corrective actions to be taken on the display interface.

4. The computer-implemented method of claim 1, further comprising:
dynamically allocating one or more maintenance tasks associated with the failure based, at least in part, upon historical data trends.

5. The computer-implemented method of claim 4, wherein the one or more maintenance tasks are dynamically allocated based further in part upon one or more policies defining skillsets required for handling the one or more maintenance tasks.

6. The computer-implemented method of claim 1, wherein associating the one or more applications with the one or more related applications further comprises:
associating one or more parent nodes of the one or more applications with one or more child nodes of the one or more related applications in a data structure.

7. The computer-implemented method of claim 1, wherein causing the at least one change to the one or more components based on the determined cause further comprises:
causing an adjustment in at least one operating state for at least one of the one or more components.

8. A system, comprising:
at least one processor; and
memory storing instructions that, when executed by the at least one processor, cause the at least one processor to:
receive data for one or more applications associated with one or more operational functionalities of a data center;
associate the one or more applications with one or more related applications;
detect a failure of one or more components monitored by the one or more applications or the one or more related applications;
determine a cause of the failure based, at least in part, upon detected changes and contextual information associated with the failure; and
cause at least one change to the one or more components based on the determined cause of the failure.

9. The system of claim 8, wherein the cause of the failure is determined using at least one neural network trained to:
observe and extract the contextual information from a surrounding environment, and
generate one or more recommendations related to the failure.

10. The system of claim 8, wherein the instructions, when executed by the at least one processor, cause the at least one processor to further:
generate a service ticket identifying the root cause of the failure; and
provide the service ticket and one or more corrective actions to be taken on the display interface.

11. The system of claim 8, wherein the instructions, when executed by the at least one processor, cause the at least one processor to further:
dynamically allocate one or more maintenance tasks associated with the failure based, at least in part, upon historical data trends.

12. The system of claim 11, wherein the one or more maintenance tasks are dynamically allocated based further in part upon one or more policies defining skillsets required for handling the one or more maintenance tasks.

13. The system of claim 8, wherein associating the one or more applications with the one or more related applications further comprises:
associating one or more parent nodes of the one or more applications with one or more child nodes of the one or more related applications in a data structure.

14. The system of claim 8, wherein causing the at least one change to the one or more components based on the determined cause further comprises:
causing an adjustment in at least one operating state for at least one of the one or more components.

15. A non-transitory computer-readable medium, storing instructions which, when executed by at least one processor, cause the at least one processor to:
receive data for one or more applications associated with one or more operational functionalities of a data center;
associate the one or more applications with one or more related applications;
detect a failure of one or more components monitored by the one or more applications or the one or more related applications;
determine a cause of the failure based, at least in part, upon detected changes and contextual information associated with the failure; and
cause at least one change to the one or more components based on the determined cause of the failure.

16. The non-transitory computer-readable medium of claim 15, wherein the cause of the failure is determined using at least one neural network trained to:
observe and extract the contextual information from a surrounding environment, and
generate one or more recommendations related to the failure.

17. The non-transitory computer-readable medium of claim 15, wherein the instructions, when executed by the at least one processor, cause the at least one processor to further:
generate a service ticket identifying the root cause of the failure; and
provide the service ticket and one or more corrective actions to be taken on the display interface.

18. The non-transitory computer-readable medium of claim 15, wherein the instructions, when executed by the at least one processor, cause the at least one processor to further:
dynamically allocate one or more maintenance tasks associated with the failure based, at least in part, upon historical data trends.

19. The non-transitory computer-readable medium of claim 15, wherein associating the one or more applications with the one or more related applications further comprises:
associating one or more parent nodes of the one or more applications with one or more child nodes of the one or more related applications in a data structure.

20. The non-transitory computer-readable medium of claim 15, wherein causing the at least one change to the one or more components based on the determined cause further comprises:
causing an adjustment in at least one operating state for at least one of the one or more components.
